(19) United States
(12) Patent Application Publication
(10) Pub. No.: US 2025/0028469 A1
(43) Pub. Date: Jan. 23, 2025

(54) SMART DATA PLACEMENT

(71) Applicant: Dropbox, Inc., San Francisco, CA (US)

(72) Inventors: Ankur Kulshrestha, Issaquah, WA (US); Sandeep Kumar R. Ummadi, Issaquah, WA (US); Facundo Agriel, Seattle, WA (US); David Robb, Seattle, WA (US); Eric Shobe, Larkspur, CA (US); Jared Mednick, Dublin (IE)

(21) Appl. No.: 18/225,058

(22) Filed: Jul. 21, 2023

(51) Int. Cl. G06F 3/06; G06F 11/00; G06F 11/34; G11B 20/18

(52) U.S. Cl. CPC G06F 3/0647; G06F 3/0619; G06F 3/0653; G06F 3/0676; G06F 11/008; G06F 11/3447; G11B 20/18

(57) ABSTRACT

The system obtains performance signals associated with respective hard disks of a volume of hard disks including a plurality of hard disks that are dedicated to activities of a service. The system determines a volume failure prediction for the volume of hard disks by, for each respective hard disk of the volume of hard disks, determining a hard disk failure prediction. The system determines a hard disk failure prediction by: inputting the respective performance signals into a supervised machine learning model; and receiving as output from the machine learning model the hard disk failure prediction for the respective hard disk. The system based on the received outputs, determines that the volume failure prediction is associated with a migration condition. The system, responsive to determining that the volume failure prediction is associated with the migration condition, migrates data from the volume of hard disks to a second volume of hard disks.

### TECHNICAL FIELD

The disclosed embodiments generally relate to the monitoring of a volume of hard disk drives via a machine learning model to predict hard disk drive failure in order to balance the needs of system reliability and efficiency.

### BACKGROUND

Disk reliability is critical to durability and availability guarantees. There are systems and processes to continuously monitor faulty disk and ensure faulty disks are fixed or swapped out to keep a storage fleet healthy. Vendors typically state the lifespan of a hard disk drive. For example, industry standard practices can be to have a lifespan of 5 years. Beyond the lifespan stated by the vendor, the hard disk drive's reliability is unknown—making it risky to keep them in a system. This requires proactively taking out aging hardware and replacing it—while it is still working, as it nears the end of that 5-year lifespan. This creates inefficiencies of not using hard disk drive resources to their full capacity in order to comply with durability and availability guarantees that are made for data storage and access.

### SUMMARY

By monitoring the performance of a fleet of hard disk drives, and using a machine learning model trained on signals from performance of such hard disk drives, the systems and methods disclosed herein can more accurately determine when a volume of hard disk drives is at risk of failure based on the performance of individual hard disk drives within the volume, which is an improvement relative to implementations that rely on a generic standard of five years for individual hard disk drives, or waiting until the individual hard disk drives fail. By monitoring the ongoing performance of volumes of hard disk drives, and using the supervised machine learning model that has been trained on such hard disk drives, the system determines the failure prediction for each hard disk drive, and risk for a volume of hard disk drives can be determined therefrom. When the number of hard disk drives with a high hard disk drive failure prediction satisfies a given threshold, or otherwise matches a condition for migration, the system may cause a migration of the data from that volume of hard disk drives to another volume of hard disk drives determined to be at lower risk, and may remove the highest risk hard disk drives from the initial volume from deployment.

In some embodiments, a storage health module obtains respective performance signals associated with respective hard disk drives of a volume of hard disk drives. The volume of hard disk drives includes a plurality of hard disk drives that are dedicated to activities of a service. The storage health module may determine a volume failure prediction for the volume of hard disk drives by, for each respective hard disk drive of the volume of hard disk drives, determining a hard disk drive failure prediction by: inputting the respective performance signals into a supervised machine learning model; and receiving as output from the machine learning model the hard disk drive failure prediction for the respective hard disk drive. The storage health module may determine, based on the received outputs, that the volume failure prediction for is associated with a migration condition; and responsive to determining that the volume failure prediction is associated with the migration condition, may cause a migration data from the volume of hard disk drives to a second volume of hard disk drives.

In some embodiments, the storage health module obtains respective performance signals associated with respective platters of a particular hard disk drive. For each respective platter of the particular hard disk drive, the storage health module inputs the respective performance signals associated with each respective platter into a second supervised machine learning model; and receives as output from the second supervised machine learning model a platter failure prediction for the respective platter.

In some embodiments, the storage health module determines, based on the platter failure prediction, that the hard disk drive failure prediction is associated with a second migration condition; and responsive to determining the hard disk drive failure prediction is associated with the second migration condition, cause a migration of data on the particular hard disk drive to a second particular hard disk drive.

In some embodiments, the storage health module, when the volume of hard disk drives comprises a number of hard disk drives, identifies a second number of hard disk drives to be included in the second volume of hard disk drives, such that the number of hard disk drives in the volume of hard disk drives is not equal to the second number of hard disk drives to be included in the second volume of hard disk drives.

In some embodiments, the storage health module, responsive to receiving the hard disk drive failure prediction as output, calculates a risk failure rating for each respective hard disk drive, the risk failure rating comprising a classification of a given plurality of candidate classifications.

In some embodiments, the storage health module, determines a number of respective hard disk drives which received a given classification, wherein the given classification is associated with a threshold associated with the migration condition; and determines that the number of respective hard disk drives which received the given classification satisfies the threshold associated with the migration condition.

In some embodiments, the storage health module, responsive to receiving the platter failure prediction as output, calculates a platter risk failure rating for each respective platter, the platter risk failure rating comprising a second classification of a given second plurality of candidate classifications.

### BRIEF DESCRIPTION OF THE DRAWINGS

FIG. 1 shows a diagram of a system environment of a content management system and a collaborative content management system, according to example embodiments.

FIG. 2 shows a block diagram of components of a client device, according to example embodiments.

FIG. 3 shows a block diagram of a content management system, according to example embodiments.

FIG. 4 shows a block diagram of a collaborative content management system, according to example embodiments.

FIG. 5 shows a block diagram of a smart data placement system, according to example embodiments.

FIG. 6 shows a block diagram of a smart data placement process, according to example embodiments.

FIG. 7 shows a block diagram a block diagram illustrating a process for determine a volume failure prediction, according to example embodiments.

FIG. 8 shows a flow diagram of smart data placement system, according to example embodiments.

The figures depict various example embodiments of the present technology for purposes of illustration only. One skilled in the art will readily recognize from the following description that other alternative example embodiments of the structures and methods illustrated herein may be employed without departing from the principles of the technology described herein.

### DETAILED DESCRIPTION

### System Overview

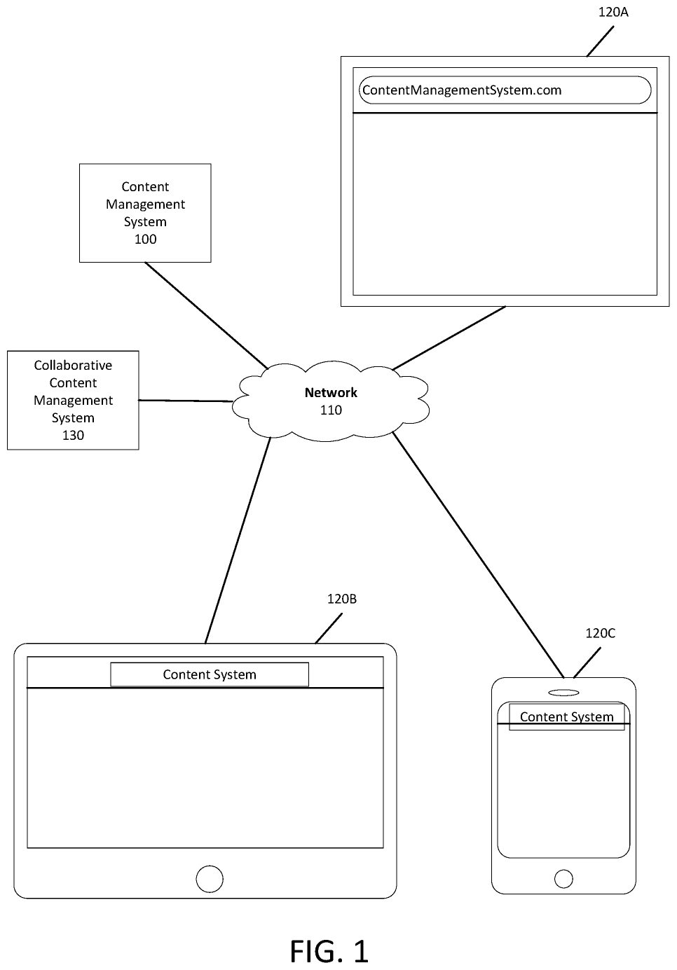

FIG. 1 shows a system environment including content management system 100, collaborative content management system 130, and client devices 120a, 120b, and 120c (collectively or individually “120”). Content management system 100 provides functionality for sharing content items with one or more client devices 120 and synchronizing content items between content management system 100 and one or more client devices 120.

The content stored by content management system 100 can include any type of content items, such as documents, spreadsheets, collaborative content items, text files, audio files, image files, video files, webpages, executable files, binary files, placeholder files that reference other content items, etc. In some implementations, a content item can be a portion of another content item, such as an image that is included in a document. Content items can also include collections, such as folders, namespaces, playlists, albums, etc., that group other content items together. The content stored by content management system 100 may be organized in one configuration in folders, tables, or in other database structures (e.g., object oriented, key/value etc.).

In some example embodiments, the content stored by content management system 100 includes content items created by using third party applications, e.g., word processors, video and image editors, database management systems, spreadsheet applications, code editors, and so forth, which are independent of content management system 100.

In some example embodiments, content stored by content management system 100 includes content items, e.g., collaborative content items, created using a collaborative interface provided by collaborative content management system 130. In various implementations, collaborative content items can be stored by collaborative content item management system 130, with content management system 100, or external to content management system 100. A collaborative interface can provide an interactive content item collaborative platform whereby multiple users can simultaneously create and edit collaborative content items, comment in the collaborative content items, and manage tasks within the collaborative content items.

Users may create accounts at content management system 100 and store content thereon by sending such content from client device 120 to content management system 100. The content can be provided by users and associated with user accounts that may have various privileges. For example, privileges can include permissions to: see content item titles, see other metadata for the content item (e.g. location data, access history, version history, creation/modification dates, comments, file hierarchies, etc.), read content item contents, modify content item metadata, modify content of a content item, comment on a content item, read comments by others on a content item, or grant or remove content item permissions for other users.

Client devices 120 communicate with content management system 100 and collaborative content management system 130 through network 110. The network may be any suitable communications network for data transmission. In some example embodiments, network 110 is the Internet and uses standard communications technologies and/or protocols. Thus, network 110 can include links using technologies such as Ethernet, 802.11, worldwide interoperability for microwave access (WiMAX), 3G, 4G, digital subscriber line (DSL), asynchronous transfer mode (ATM), InfiniBand, PCI Express Advanced Switching, etc. Similarly, the networking protocols used on network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over network 110 can be represented using technologies and/or formats including the hypertext markup language (HTML), the extensible markup language (XML), JavaScript Object Notation (JSON), etc. In addition, all or some of links can be encrypted using conventional encryption technologies such as the secure sockets layer (SSL), transport layer security (TLS), virtual private networks (VPNs), Internet Protocol security (IPsec), etc. In some example embodiments, the entities use custom and/or dedicated data communications technologies instead of, or in addition to, the ones described above.

In some example embodiments, content management system 100 and collaborative content management system 130 are combined into a single system. The system may include one or more servers configured to provide the functionality discussed herein for the systems 100 and 130.

### Client Device

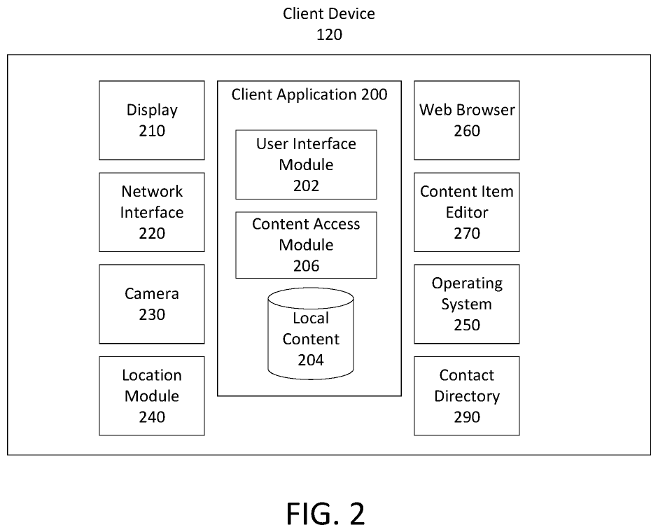

FIG. 2 shows a block diagram of the components of a client device 120 according to example embodiments. Client devices 120 generally include devices and modules for communicating with content management system 100 and a user of client device 120. Client device 120 includes display 210 for providing information to the user, and in certain client devices 120 includes a touchscreen. Client device 120 also includes network interface 220 for communicating with content management system 100 via network 110. There are additional components that may be included in client device 120 but that are not shown, for example, one or more computer processors, local fixed memory (RAM and ROM), as well as optionally removable memory (e.g., SD-card), power sources, and audio-video outputs.

In certain example embodiments, client device 120 includes additional components such as camera 230 and location module 240. Location module 240 determines the location of client device 120, using, for example, a global positioning satellite signal, cellular tower triangulation, or other methods. Location module 240 may be used by client application 200 to obtain location data and add the location data to metadata about a content item.

Client devices 120 maintain various types of components and modules for operating the client device and accessing content management system 100. The software modules can include operating system 250 or a collaborative content item editor 270. Collaborative content item editor 270 is configured for creating, viewing and modifying collaborative content items such as text documents, code files, mixed media files (e.g., text and graphics), presentations or the like. Operating system 250 on each device provides a local file management system and executes the various software modules such as content management system client application 200 and collaborative content item editor 270. A contact directory 290 stores information on the user's contacts, such as name, telephone numbers, company, email addresses, physical address, website URLs, and the like.

Client devices 120 access content management system 100 and collaborative content management system 130 in a variety of ways. Client device 120 may access these systems through a native application or software module, such as content management system client application 200. Client device 120 may also access content management system 100 through web browser 260. As an alternative, the client application 200 may integrate access to content management system 100 with the local file management system provided by operating system 250. When access to content management system 100 is integrated in the local file management system, a file organization scheme maintained at the content management system is represented at the client device 120 as a local file structure by operating system 250 in conjunction with client application 200.

Client application 200 manages access to content management system 100 and collaborative content management system 130. Client application 200 includes user interface module 202 that generates an interface to the content accessed by client application 200 and is one means for performing this function. The generated interface is provided to the user by display 210. Client application 200 may store content accessed from a content storage at content management system 100 in local content 204. While represented here as within client application 200, local content 204 may be stored with other data for client device 120 in non-volatile storage. When local content 204 is stored this way, the content is available to the user and other applications or modules, such as collaborative content item editor 270, when client application 200 is not in communication with content management system 100. Content access module 206 manages updates to local content 204 and communicates with content management system 100 to synchronize content modified by client device 120 with content maintained on content management system 100, and is one means for performing this function. Client application 200 may take various forms, such as a stand-alone application, an application plug-in, or a browser extension.

### Content Management System

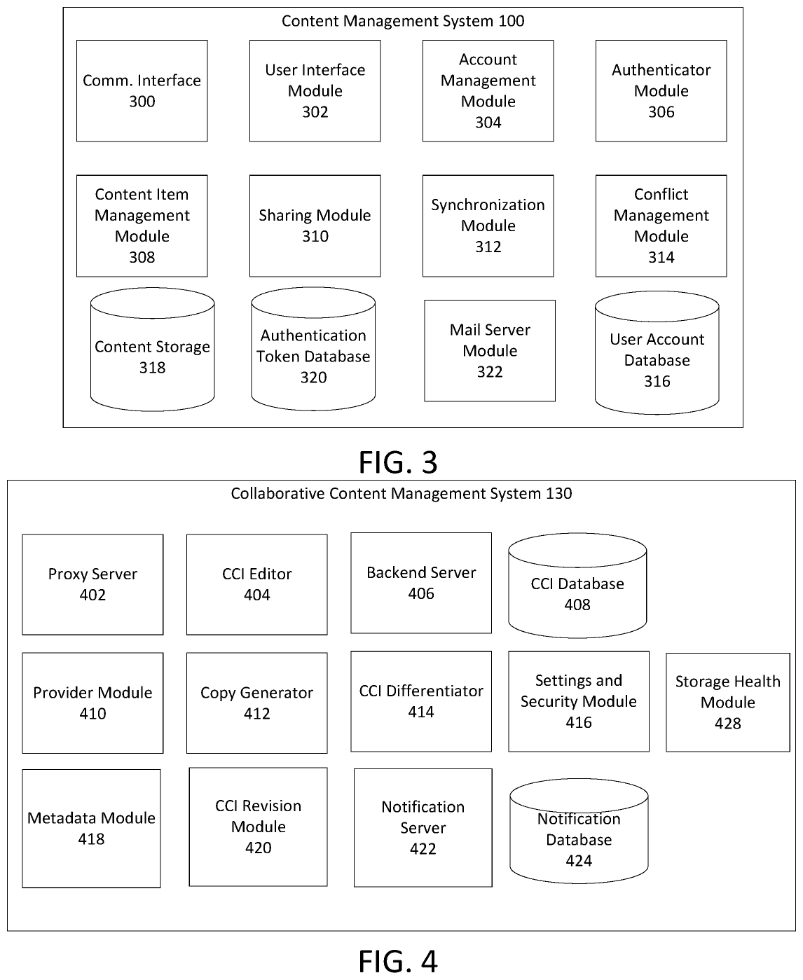

FIG. 3 shows a block diagram of the content management system 100 according to example embodiments. To facilitate the various content management services, a user can create an account with content management system 100. The account information can be maintained in user account database 316, and is one means for performing this function. User account database 316 can store profile information for registered users. In some cases, the only personal information in the user profile is a username and/or email address. However, content management system 100 can also be configured to accept additional user information, such as password recovery information, demographics information, payment information, and other details. Each user is associated with a userID and a user name. For purposes of convenience, references herein to information such as collaborative content items or other data being “associated” with a user are understood to mean an association between a collaborative content item and either of the above forms of user identifier for the user. Similarly, data processing operations on collaborative content items and users are understood to be operations performed on derivative identifiers such as collaborativeContentItemID and userIDs. For example, a user may be associated with a collaborative content item by storing the information linking the userID and the collaborativeContentItemID in a table, file, or other storage formats. For example, a database table organized by collaborativeContentItemIDs can include a column listing the userID of each user associated with the collaborative content item. As another example, for each userID, a file can list a set of collaborativeContentItemID associated with the user. As another example, a single file can list key values pairs such as <userID, collaborativeContentItemID>representing the association between an individual user and a collaborative content item. The same types of mechanisms can be used to associate users with comments, threads, text elements, formatting attributes, and the like.

User account database 316 can also include account management information, such as account type, e.g. free or paid; usage information for each user, e.g., file usage history; maximum storage space authorized; storage space used; content storage locations; security settings; personal configuration settings; content sharing data; etc. Account management module 304 can be configured to update and/or obtain user account details in user account database 316. Account management module 304 can be configured to interact with any number of other modules in content management system 100.

An account can be used to store content items, such as collaborative content items, audio files, video files, etc., from one or more client devices associated with the account. Content items can be shared with multiple users and/or user accounts. In some implementations, sharing a content item can include associating, using sharing module 310, the content item with two or more user accounts and providing for user permissions so that a user that has authenticated into one of the associated user accounts has a specified level of access to the content item. That is, the content items can be shared across multiple client devices of varying type, capabilities, operating systems, etc. The content items can also be shared across varying types of user accounts.

Individual users can be assigned different access privileges to a content item shared with them, as discussed above. In some cases, a user's permissions for a content item can be explicitly set for that user. A user's permissions can also be set based on: a type or category associated with the user (e.g., elevated permissions for administrator users or manager), the user's inclusion in a group or being identified as part of an organization (e.g., specified permissions for all members of a particular team), and/or a mechanism or context of a user's accesses to a content item (e.g., different permissions based on where the user is, what network the user is on, what type of program or API the user is accessing, whether the user clicked a link to the content item, etc.). Additionally, permissions can be set by default for users, user types/groups, or for various access mechanisms and contexts.

In some implementations, shared content items can be accessible to a recipient user without requiring authentication into a user account. This can include sharing module 310 providing access to a content item through activation of a link associated with the content item or providing access through a globally accessible shared folder.

The content can be stored in content storage 318, which is one means for performing this function. Content storage 318 can be a storage device, multiple storage devices, or a server. Alternatively, content storage 318 can be a cloud storage provider or network storage accessible via one or more communications networks. In one configuration, content management system 100 stores the content items in the same organizational structure as they appear on the client device. However, content management system 100 can store the content items in its own order, arrangement, or hierarchy.

Content storage 318 can also store metadata describing content items, content item types, and the relationship of content items to various accounts, folders, or groups. The metadata for a content item can be stored as part of the content item or can be stored separately. In one configuration, each content item stored in content storage 318 can be assigned a system-wide unique identifier.

Content storage 318 can decrease the amount of storage space required by identifying duplicate files or duplicate segments of files. Instead of storing multiple copies of an identical content item, content storage 318 can store a single copy and then use a pointer or other mechanism to link the duplicates to the single copy. Similarly, content storage 318 stores files using a file version control mechanism that tracks changes to files, different versions of files (such as a diverging version tree), and a change history. The change history can include a set of changes that, when applied to the original file version, produces the changed file version.

Content management system 100 automatically synchronizes content from one or more client devices, using synchronization module 312, which is one means for performing this function. The synchronization is platform agnostic. That is, the content is synchronized across multiple client devices 120 of varying type, capabilities, operating systems, etc. For example, client application 200 synchronizes, via synchronization module 312 at content management system 100, content in client device 120's file system with the content in an associated user account on system 100. Client application 200 synchronizes any changes to content in a designated folder and its sub-folders with the synchronization module 312. Such changes include new, deleted, modified, copied, or moved files or folders. Synchronization module 312 also provides any changes to content associated with client device 120 to client application 200. This synchronizes the local content at client device 120 with the content items at content management system 100.

Conflict management module 314 determines whether there are any discrepancies between versions of a content item located at different client devices 120. For example, when a content item is modified at one client device and a second client device, differing versions of the content item may exist at each client device. Synchronization module 312 determines such versioning conflicts, for example by identifying the modification time of the content item modifications. Conflict management module 314 resolves the conflict between versions by any suitable means, such as by merging the versions, or by notifying the client device of the later-submitted version.

A user can also view or manipulate content via a web interface generated by user interface module 302. For example, the user can navigate in web browser 260 to a web address provided by content management system 100. Changes or updates to content in content storage 318 made through the web interface, such as uploading a new version of a file, are synchronized back to other client devices 120 associated with the user's account. Multiple client devices 120 may be associated with a single account and files in the account are synchronized between each of the multiple client devices 120.

Content management system 100 includes communications interface 300 for interfacing with various client devices 120, and with other content and/or service providers via an Application Programming Interface (API), which is one means for performing this function. Certain software applications access content storage 318 via an API on behalf of a user. For example, a software package, such as an app on a smartphone or tablet computing device, can programmatically make calls directly to content management system 100, when a user provides credentials, to read, write, create, delete, share, or otherwise manipulate content. Similarly, the API can allow users to access all or part of content storage 318 through a web site.

Content management system 100 can also include authenticator module 306, which verifies user credentials, security tokens, API calls, specific client devices, etc., to determine whether access to requested content items is authorized, and is one means for performing this function. Authenticator module 306 can generate one-time use authentication tokens for a user account. Authenticator module 306 assigns an expiration period or date to each authentication token. In addition to sending the authentication tokens to requesting client devices, authenticator module 306 can store generated authentication tokens in authentication token database 320. After receiving a request to validate an authentication token, authenticator module 306 checks authentication token database 320 for a matching authentication token assigned to the user. Once the authenticator module 306 identifies a matching authentication token, authenticator module 306 determines if the matching authentication token is still valid. For example, authenticator module 306 verifies that the authentication token has not expired or was not marked as used or invalid. After validating an authentication token, authenticator module 306 may invalidate the matching authentication token, such as a single-use token. For example, authenticator module 306 can mark the matching authentication token as used or invalid, or delete the matching authentication token from authentication token database 320.

In some example embodiments, content management system 100 includes a content management module 308 for maintaining a content directory that identifies the location of each content item in content storage 318, and allows client applications to request access to content items in the storage 318, and which is one means for performing this function. A content entry in the content directory can also include a content pointer that identifies the location of the content item in content storage 318. For example, the content entry can include a content pointer designating the storage address of the content item in memory. In some example embodiments, the content entry includes multiple content pointers that point to multiple locations, each of which contains a portion of the content item.

In addition to a content path and content pointer, a content entry in some configurations also includes user account identifier that identifies the user account that has access to the content item. In some example embodiments, multiple user account identifiers can be associated with a single content entry indicating that the content item has shared access by the multiple user accounts.

In some example embodiments, the content management system 100 can include a mail server module 322. The mail server module 322 can send (and receive) collaborative content items to (and from) other client devices using the collaborative content management system 100. The mail server module can also be used to send and receive messages between users in the content management system.

### Collaborative Content Management System

FIG. 4 shows a block diagram of the collaborative content management system 130, according to example embodiments. Collaborative content items can be files that users can create and edit using a collaborative content items editor 270 and can contain collaborative content item elements. Collaborative content item elements may include any type of content such as text; images, animations, videos, audio, or other multi-media; tables; lists; references to external content; programming code; tasks; tags or labels; comments; or any other type of content. Collaborative content item elements can be associated with an author identifier, attributes, interaction information, comments, sharing users, etc. Collaborative content item elements can be stored as database entities, which allows for searching and retrieving the collaborative content items. As with other types of content items, collaborative content items may be shared and synchronized with multiple users and client devices 120, using sharing module 310 and synchronization module 312 of content management system 100. Users operate client devices 120 to create and edit collaborative content items, and to share collaborative content items with other users of client devices 120. Changes to a collaborative content item by one client device 120 are propagated to other client devices 120 of users associated with that collaborative content item.

In example embodiments of FIG. 1, collaborative content management system 130 is shown as separate from content management system 100 and can communicate with it to obtain its services. In other example embodiments, collaborative content management system 130 is a subsystem of the component of content management system 100 that provides sharing and collaborative services for various types of content items. User account database 316 and authentication token database 320 from content management system 100 are used for accessing collaborative content management system 130 described herein.

Collaborative content management system 130 can include various servers for managing access and edits to collaborative content items and for managing notifications about certain changes made to collaborative content items. Collaborative content management system 130 can include proxy server 402, collaborative content item editor 404, backend server 406, and collaborative content item database 408, access link module 410, copy generator 412, collaborative content item differentiator 414, settings module 416, metadata module 418, revision module 420, notification server 422, and notification database 424. Proxy server 402 handles requests from client applications 200 and passes those requests to the collaborative content item editor 404. Collaborative content item editor 404 manages application level requests for client applications 200 for editing and creating collaborative content items, and selectively interacts with backend servers 406 for processing lower level processing tasks on collaborative content items, and interfacing with collaborative content items database 408 as needed. Collaborative content items database 408 contains a plurality of database objects representing collaborative content items, comment threads, and comments. Each of the database objects can be associated with a content pointer indicating the location of each object within the CCI database 408. Notification server 422 detects actions performed on collaborative content items that trigger notifications, creates notifications in notification database 424, and sends notifications to client devices.

Client application 200 sends a request relating to a collaborative content item to proxy server 402. Generally, a request indicates the userID (“UID”) of the user, and the collaborativeContentItemID (“NID”) of the collaborative content item, and additional contextual information as appropriate, such as the text of the collaborative content item. When proxy server 402 receives the request, the proxy server 402 passes the request to the collaborative content item editor 404. Proxy server 402 also returns a reference to the identified collaborative content items proxy server 402 to client application 200, so the client application can directly communicate with the collaborative content item editor 404 for future requests. In alternative example embodiments, client application 200 initially communicates directly with a specific collaborative content item editor 404 assigned to the userID.

When collaborative content item editor 404 receives a request, it determines whether the request can be executed directly or by a backend server 406. When the request adds, edits, or otherwise modifies a collaborative content item the request is handled by the collaborative content item editor 404. If the request is directed to a database or index inquiry, the request is executed by a backend server 406. For example, a request from client device 120 to view a collaborative content item or obtain a list of collaborative content items responsive to a search term is processed by backend server 406.

The access module 410 receives a request to provide a collaborative content item to a client device. In some example embodiments, the access module generates an access link to the collaborative content item, for instance in response to a request to share the collaborative content item by an author. The access link can be a hyperlink including or associated with the identification information of the CCI (i.e., unique identifier, content pointer, etc.). The hyperlink can also include any type of relevant metadata within the content management system (i.e., author, recipient, time created, etc.). In some example embodiments, the access module can also provide the access link to user accounts via the network 110, while in other example embodiments the access link can be provided or made accessible to a user account and is accessed through a user account via the client device. In some example embodiments, the access link will be a hyperlink to a landing page (e.g., a webpage, a digital store front, an application login, etc.) and activating the hyperlink opens the landing page on a client device. The landing page can allow client devices not associated with a user account to create a user account and access the collaborative content item using the identification information associated with the access link. Additionally, the access link module can insert metadata into the collaborative content item, associate metadata with the collaborative content item, or access metadata associated with the collaborative content item that is requested.

The access module 410 can also provide collaborative content items via other methods. For example, the access module 410 can directly send a collaborative content item to a client device or user account, store a collaborative content item in a database accessible to the client device, interact with any module of the collaborative content management system to provide modified versions of collaborative content items (e.g., the copy generator 412, the CCI differentiator 414, etc.), sending content pointer associated with the collaborative content item, sending metadata associated with the collaborative content item, or any other method of providing collaborative content items between devices in the network. The access module can also provide collaborative content items via a search of the collaborative content item database (i.e., search by a keyword associated with the collaborative content item, the title, or a metadata tag, etc.).

The copy generator 412 can duplicate a collaborative content item. Generally, the copy generator duplicates a collaborative content item when a client device selects an access link associated with the collaborative content item. The copy generator 412 accesses the collaborative content item associated with the access link and creates a derivative copy of the collaborative content item for every request received. The copy generator 412 stores each derivative copy of the collaborative content item in the collaborative content item database 408. Generally, each copy of the collaborative content item that is generated by the copy generator 412 is associated with both the client device from which the request was received, and the user account associated with the client device requesting the copy. When the copy of the collaborative content item is generated, it can create a new unique identifier and content pointer for the copy of the collaborative content item. Additionally, the copy generator 412 can insert metadata into the collaborative content item, associate metadata with the copied collaborative content item, or access metadata associated with the collaborative content item that was requested to be copied.

The collaborative content item differentiator 414 determines the difference between two collaborative content items. In some example embodiments, the collaborative content item differentiator 414 determines the difference between two collaborative content items when a client device selects an access hyperlink and accesses a collaborative content item that the client device has previously used the copy generator 412 to create a derivative copy. The content item differentiator can indicate the differences between the content elements of the compared collaborative content items. The collaborative content item differentiator 414 can create a collaborative content item that includes the differences between the two collaborative content items, i.e., a differential collaborative content item. In some example embodiments, the collaborative content item differentiator provides the differential collaborative content item to a requesting client device 120. The differentiator 414 can store the differential collaborative content item in the collaborative content item database 408 and generate identification information for the differential collaborative content item. Additionally, the differentiator 414 can insert metadata into the accessed and created collaborative content items, associate metadata with the accessed and created collaborative content item, or access metadata associated with the collaborative content items that were requested to be differentiated.

The settings and security module 416 can manage security during interactions between client devices 120, the content management system 100, and the collaborative content management system 130. Additionally, the settings and security module 416 can manage security during interactions between modules of the collaborative content management system. For example, when a client device 120 attempts to interact within any module of the collaborative content management system 100, the settings and security module 416 can manage the interaction by limiting or disallowing the interaction. Similarly, the settings and security module 416 can limit or disallow interactions between modules of the collaborative content management system 130. Generally, the settings and security module 416 accesses metadata associated with the modules, systems 100 and 130, devices 120, user accounts, and collaborative content items to determine the security actions to take. Security actions can include: requiring authentication of client devices 120 and user accounts, requiring passwords for content items, removing metadata from collaborative content items, preventing collaborative content items from being edited, revised, saved, or copied, or any other security similar security action. Additionally, settings and security module can access, add, edit, or delete any type of metadata associated with any element of content management system 100, collaborative content management system 130, client devices 120, or collaborative content items.

The metadata module 418 manages metadata within with the collaborative content management system. Generally, metadata can take three forms within the collaborative content management system: internal metadata, external metadata, and device metadata. Internal metadata is metadata within a collaborative content item, external metadata is metadata associated with a CCI but not included or stored within the CCI itself, and device metadata is associated with client devices. At any point, the metadata module can manage metadata by changing, adding, or removing metadata.

Some examples of internal metadata can be: identifying information within collaborative content items (e.g., email addresses, names, addresses, phone numbers, social security numbers, account or credit card numbers, etc.); metadata associated with content elements (e.g., location, time created, content element type; content element size; content element duration, etc.); comments associated with content elements (e.g., a comment giving the definition of a word in a collaborative content item and its attribution to the user account that made the comment); or any other metadata that can be contained within a collaborative content item.

Some examples of external metadata can be: content tags indicating categories for the metadata; user accounts associated with a CCI (e.g., author user account, editing user account, accessing user account etc.); historical information (e.g., previous versions, access times, edit times, author times, etc.); security settings; identifying information (e.g., unique identifier, content pointer); collaborative content management system 130 settings; user account settings; or any other metadata that can be associated with the collaborative content item.

Some examples of device metadata can be: device type; device connectivity; device size; device functionality; device sound and display settings; device location; user accounts associated with the device; device security settings; or any other type of metadata that can be associated with a client device 120.

The collaborative content item revision module 420 manages application level requests for client applications 200 for revising differential collaborative content items and selectively interacts with backend servers 406 for processing lower level processing tasks on collaborative content items, and interfacing with collaborative content items database 408 as needed. The revision module can create a revised collaborative content item that is some combination of the content elements from the differential collaborative content item. The revision module 420 can store the revised collaborative content item in the collaborative content item database or provide the revised collaborative content item to a client device 120. Additionally, the revision module 420 can insert metadata into the accessed and created collaborative content items, associate metadata with the accessed and created collaborative content item, or access metadata associated with the collaborative content items that were requested to be differentiated.

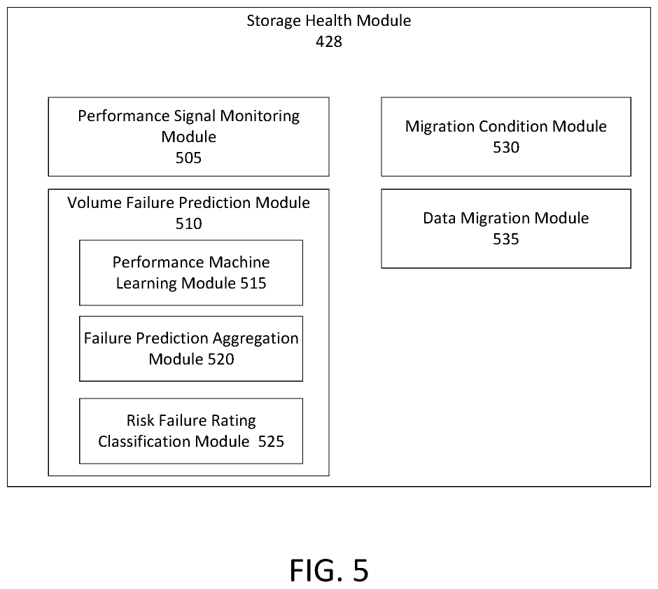

The storage health module 428 manages the monitoring of storage medium, such as hard disk drives, as well as the migration of data between the storage medium to ensure smart disk placement for the protection of the data. The storage health module 428 may monitor the storage medium associated with servers hosting data for the content management system 100 and collaborative content management system 130, such as backend server 406 or CCI database 408. The storage health module 428 may be hosted on either content management system 100 or collaborative content management system 130 and may include processes which occur on any device connected to network 110. Further details relating to operation of the storage health module 428 are described below with respect to FIGS. 5-8.

Content management system 100 and collaborative content management system 130 may be implemented using a single computer, or a network of computers, including cloud-based computer implementations. The operations of content management system 100 and collaborative content management system 130 as described herein can be controlled through either hardware or through computer programs installed in computer storage and executed by the processors of such server to perform the functions described herein. These systems include other hardware elements necessary for the operations described here, including network interfaces and protocols, input devices for data entry, and output devices for display, printing, or other presentations of data, but which are not described herein. Similarly, conventional elements, such as firewalls, load balancers, collaborative content items servers, failover servers, network management tools and so forth are not shown so as not to obscure the features of the system. Finally, the functions and operations of content management system 100 and collaborative content management system 130 are sufficiently complex as to require implementation on a computer system, and cannot be performed in the human mind simply by mental steps.

FIG. 5 shows a block diagram of a smart data placement system, according to example embodiments. FIG. 5 shows the storage health module 428 and the function submodules within it, including a performance signal monitoring module 505, a volume failure prediction module 510, a migration condition module 530, and a data migration module 535. The volume failure prediction module 510 may include a performance learning module 515, and a failure prediction aggregation module 520, and a risk failure classification module 525. This is just one example embodiment, and the storage health module may include fewer more modules or a different combination of modules to achieve the functionality disclosed herein. The embodiment shown in FIG. 5 illustrates the use of hard disk drives as the storage medium. In alternate embodiments, discussed further below, alternate embodiments of the storage medium may be used.

The performance signal monitoring module 505 obtains performance signals associated with hard disk drives of a volume of hard disk drives. As used herein, the term “performance signal” may refer to any attributes, features, measurements, or variables relating to the health of the measured component, such as a hard disk drive, platter, central processing unit (CPU), or solid-state drive. Exemplary performance signals may include a series of features, variables and/or metrics describing the status of a hard disk drive. As an example, the identifying features may include any combination of read error rate, throughput performance, spin-up time, star/stop count, reallocated sectors count, read channel margin, seek error rate, and other S.M.A.R.T attributes. S.M.A.R.T. attributes are attributes from the Self-Monitoring, Analysis and Reporting Technology monitoring system for hard disk drives and solid-state drives. Other sources of performance attributes include FARM metrics, vendor specific logs, OSD2 failures, disk I/O failure error codes, and more. These features may be represented in a vector format, such as “[‘hwclass’, ‘hwrev’, ‘hostname’, ‘component_id’, ‘wwn’].” The vector format allows for a convenient organization of data for using in machine learning models and process.

One example of an attribute that reflects the health of a hard disk drive is spin-up time, which is the time (e.g., in milliseconds) that a drive takes to get up to operational speed. The charting of the performance of hard disk drives based on spin-up time indicates that many of the hard disk drives identified for decommissioning have a spin-up time greater than 400 milliseconds. Another example of an attribute that reflects the health of a hard disk drive is Highest Average Long-Term Temp. The charting of the performance of the hard disk drives indicates that the high averages shift to a temperature above 50 degrees Celsius in hard disk drives that had to be decommissioned. Another example of an attribute that reflects hard disk drive health is Raw Read Error Rate, which indicates hardware problems based on the frequency of errors.

As used herein, the term “volume of hard disk drives” is a collection of hard disk drives that are used to service a given application. For example, the services related to a given application may include the data storage and retrieval relating to the application, and/or the indexing of that data. The number of hard disk drives included in a hard disk drive may vary, weighing factors of both efficiency and redundancy. For given volumes, the volume failure prediction module 510 predicts risk of failure of that volume. The volume failure prediction module 510 includes the performance learning module 515 and the failure prediction aggregation module 520, as well as in some embodiments, the risk failure classification module 525.

A given volume may have a threshold for a number of hard disk drives failures it can tolerate. For any given volume, there are a number of hard disk drives present, typically more than required for a given task in order to provide redundancies and in order to ensure data integrity. When a threshold number of hard disk drive failures is reached, there are more failures than accounted for in the redundancy plan, and the integrity of the data can no longer be ensured. For example, a volume of 16 hard disk drives may tolerate 3 failures before it becomes a volume failure. Volume failure occurs when the number of hard disk drive failures in the volume reaches the tolerance threshold set by the policy. The policy for what constitutes a volume failure is pre-set based on the performance of volumes and the computing needs for the volumes (e.g., set by an administrator).

For each respective hard disk drive of the volume of hard disk drives, the volume failure prediction module 510 inputs the respective performance signals into a supervised machine learning model hosted in the performance learning module 515, and receives an indication of risk failure. The risk failure may be indicated by a discrete classification, a probability of failure, or any other representation of risk.

The supervised machine learning models in performance learning module 515 is trained based on previous performance signals and failures of hard disk drives to determine whether a given hard disk drive is expected to fail based on its current performance. The supervised machine learning modules of performance learning module 515 are trained on previous performance signals and failure rates of past hard disk drives. Data is gathered using S.M.A.R.T metrics or other alternate sources of measurements, along with information about when a hard disk drive was de-commissioned and the age of each hard disk drive. The data is cleaned to remove missing data, and fitted on a survival model to identify the variables that contribute the most predictive value to the model. The data is multivariate with over 18 possible predictors and includes a large number of records. Each model trained in this way is fit to a specific drive type, showing how the failure rate changes over time for that type of hard disk drive.

As used herein, “survival model” refers to a statistical approach utilized to analyze the time-related occurrence of an event, specifically addressing the probability that a subject, such as the hard disk drive, survives, or experiences a given event of interest over a defined period. Factors typically considered include factors which influence the likelihood of the event and provides insights into the underlying relationships within the data, enabling predictions, planning, and effective management of risks to avoid potential hazards. The machine learning model in performance learning module 515 produces both survival functions (i.e., time based on probability of survival over time) and cumulative hazard functions (i.e., time-based probability of failure over time).

The failure prediction aggregation module 520 receives as output from the machine learning model the hard disk drive failure prediction for the respective hard disk drive, and aggregates those predictions to determine the corresponding volume failure prediction for the volume of hard disk drives. The volume failure prediction for a volume indicates the health of the volume of hard disk drives as a whole, including whether that volume of hard disk drives includes enough of a diversity of hard disk drives to ensure proper efficiency as well as redundancy. The volume failure prediction indicates the level of risk that the data integrity across the volume of hard disk drives may be comprised. The failure prediction aggregation module 520 aggregates the hard disk drive failure predictions into a volume failure prediction by weighing the risks of failure of each individual hard disk drive, and calculating either the risk that data integrity may be compromised within a pre-set time window, or how long that volume of hard disks may last before data integrity is comprised. In some embodiments, the volume failure prediction may be a vector or list of all of the hard disk drive failure predictions for each hard disk drive in the volume.

The volume failure prediction module 510 includes a risk failure classification module 525, which calculates a risk failure rating based on the output of the supervised machine learning model hosted performance learning module 515. The risk failure rating includes a classification of a set of a candidate classification. For example, the candidate classifications may include a rating of a number 0 through 5, where 0 represents No Risk, and 5 represents Extreme Risk. The risk failure classification module 525 may assign to each respective hard disk drive one such rating based on the output of the supervised machine learning model hosted in performance learning module 515. The output of the supervised machine learning model includes a probability that the given hard disk drive is predicted to fail on that day. In some embodiments, responsive to the supervised machine learning model outputting a probability, the risk failure classification module 525 may assign risk failure ratings based on ranges of probability. For example, an output within the range of 0-20% may receive a rating of 1 and an output within the range of 20-40% may receive a rating of 2. The ranges of probability for assigning a rating may be pre-set by an administrator. In some embodiments, the output of the supervised machine learning model may be trained to include the rating directly such that the risk failure classification module 525 is not required.

The output of the machine learning model may include information such as the predicted time window until a given hard disk drive experiences failure. To include the information such as the predicted time window until a given hard disk drive experiences failure, the machine learning model may be trained on data including a timeline of the hard disk drives health material over time and when the respective hard disk drive failed. In this embodiment, the risk failure classification module 525 calculates the risk failure rating based on the predicted time window until a given hard disk drive experiences failure, and a set policy on whether a time horizon constitutes No Risk, Low, Risk, Medium Risk, or High Risk. For example, the pre-set policy by an administrator may designate that any hard disk drive with a predicted time window until failure less than 3 months is High Risk, and that any hard disk drive with a predicted time window until failure greater than 3 years to be No Risk.

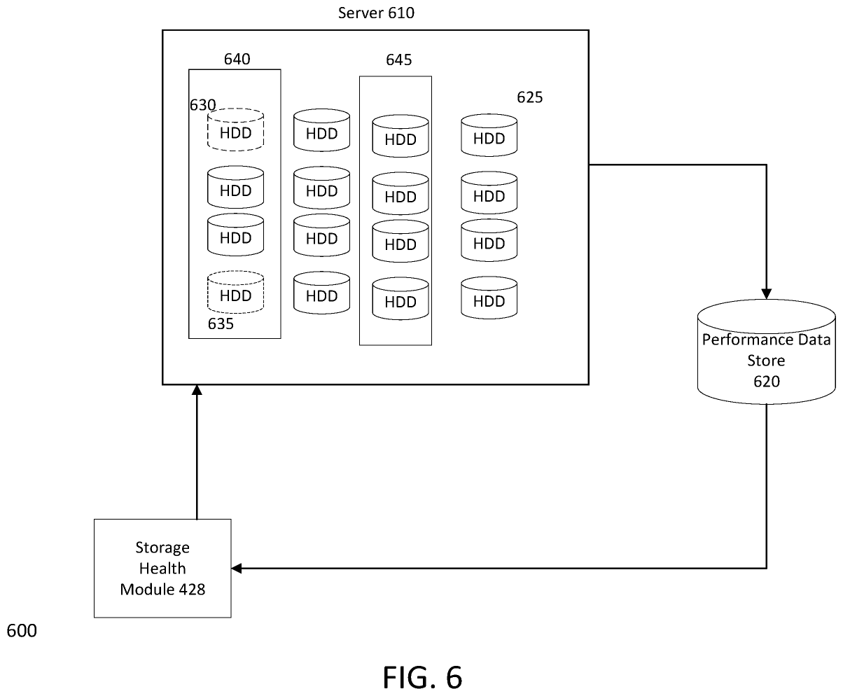

Briefly turning to FIG. 6 to further illustrate the processes of volume failure prediction module 510, FIG. 6 is illustrative of a process for monitoring health/risk. FIG. 6 shows a block diagram of a smart data placement process, according to example embodiments. The process 600 may be performed by the storage health module 428, and may be performed without human intervention. The process 600 includes activities performed with respect to a fleet of hard disk drives 610 and a performance data store 620.

The fleet of hard disk drives 610 includes a first volume of hard disk drives 640, and a second volume of hard disk drives 645, as well as a low-risk hard disk drive 625, a medium-risk hard disk drive 630, and a high-risk hard disk drive 635. Each volume of hard disk drives is a plurality of hard disk drives with each hard disk drive dedicated to storing a given set of data, or dedicated to a given service. In an alternative embodiment, the fleet of hard disk drives 610 may be an alternative data storage medium to hard disk drives such as solid-state drives in a database or central processing unit (CPU) in computer fleet.

The performance signals associated with each of the hard disk drives within the fleet of hard disk drives 610 are monitored and stored in performance data store 620. The data store 620 may be any data storage medium connected to network 100. For alternative embodiments in which fleet of hard disk drives 610 includes solid state drives or CPUs as alternatives to hard disk drives, the metrics would adapt appropriately, with some overlap. As an example, to measure the CPU health, the performance signal may include attributes relating to temperatures, and error rate. The performance signal monitoring module 505 obtains the performance signals associated with each of the hard disk drives within the first volume of hard disk drives 640 from performance data store 620. The volume failure prediction module 510 determines a volume failure prediction for the first volume of hard disk drives 640. For example, the supervised machine learning module within performance learning module 515 may determine that a hard disk drive is either a low-risk hard disk drive 625, a medium-risk hard disk drive 630 or a high-risk hard disk drive 635. The failure prediction aggregation module 520 aggregates the hard disk drive failure predictions to determine a volume failure prediction for the first volume of hard disk drives 640 as a whole. For example, responsive to determining that the first volume of hard disk drives 640 includes multiple high-risk hard disk drives 635, the failure prediction aggregation module 520 may determine that first volume of hard disk drives 640 has a high risk of failure.

Turning back to FIG. 5, the storage health module 428 includes the migration condition module 530 which determines that the volume failure prediction is associated with a migration condition. As used herein, the term “migration condition” may refer to any thresholds, risk levels, classification systems, and/or descriptions of when data needs to be migrated according to the pre-set policy. The policies describing migration conditions are set according to pre-determined acceptable risk threshold and/or tolerance. For example, a migration condition may be set such that data needs to be migrated when a threshold number of hard disk drives have reached a high-risk rating. The threshold number may be described as an absolute number or in terms of a percentage of a total. In another example, a migration condition may be set to ensure a certain amount of diversity of risk ratings within a volume, and so set to migrate data if too many hard disk drives of a volume are the same risk rating, regardless of how high a risk that is.

The policies for migration conditions may be pre-set based on testing of past hard disk drives and when past failures have occurred to cause problems with data integrity. The policies for migration conditions may be continually updated as hard disk drives are monitored and risk tolerance changes. The thresholds may also be determined based on the reliability requirements for the hard disk drives and/or the data on the hard disk drives. The storage health module 428 may continue to monitor the volumes and update the failure predictions regularly. For example, the migration condition module 530 may evaluate the failure predictions for each volume at a set frequency, such as once every 60 minutes, or once every 3 days. Responsive to determining that a first volume of hard disk drives 640 meets a migration condition, migration condition module 530 may identify specific data that need to be migrated, or may migrate any data on identified hard disk drives.

Responsive to the migration condition module 530 determining that the migration condition was met, the data migration module 535 establishes a second volume of hard disk drives 645 from the possible hard disk drives available. The data migration module 535 establishes a second volume by identifying available hard disk drives within the fleet of hard disk drives 610 which are available and designating a new collection of hard disk drives to be the second volume of hard disk drives 645. The data migration module 535 may identify the hard disk drives for the second volume such that there is a diversity of hard disk drives with varying risk classifications. For example, the data migration module 535 may identify a second volume of hard disk drives in which every hard disk drive within the second volume is has a risk failure rating between 0 and 3, where 0 is No Risk and 5 is Extremely High Risk, and in which there is a diversity such that the hard disk drives in the second volume do not all have the same risk classification. Different applications may have different risk tolerances, and the level the level of diversity required for each new volume may be set as a policy for each application.

In some embodiments, the data migration module 535 identifies the number of hard disk drives within the second volume of hard disk drives 645 to be a different number than the number of hard disk drives within the first volume of hard disk drives 640. For example, the first volume may have 16 hard disk drives and the second volume may have 20 hard disk drives. This means that for some types of data, it may be determined that more redundancy is needed, and requires copies of that data saved on more hard disks that is standard. A volume of hard disks with more hard disks in the volume can tolerate more risk failures and can have higher redundancy to mitigate higher risks. Hard disk drives that are flagged as high risk and therefore need to be removed from use may be flagged for decommission or repaired. The remaining hard disk drives in the first volume which are not yet high risk may be repurposed for continued use.

In some embodiments, the storage health module 428 and included submodules may also be used to monitor the health of individual platters within a hard disk drive. In some embodiments, the performance signal monitoring module 505 obtains a performance signal related to the activity and services on the individual platter—as opposed to or in addition to the hard disk drive as a whole. The performance signal includes metrics relates to the activities of an individual platter rather than the hard disk drive as a whole.

In some embodiments, the supervised machine learning model hosted in performance learning module 515 is trained to identify the failure and survival of individual platters, as opposed to the hard disk drive as a whole. The machine learning model to determine the failure of platters is trained based on the metrics specific to the health of platters within hard disk drives, but is otherwise similar in implementation to the other embodiments.

In some embodiments, the failure prediction aggregation module 520 receives as output from the performance learning module 515 a platter failure prediction, in the form of an indication of the predicted survival window of the platter such as for example, a likelihood of failure within a set time frame, or a predicted time window before failure occurs. The failure prediction aggregation module 520 aggregates the output platter failure predictions into an aggregated hard disk drive failure prediction. The aggregated hard disk drive failure prediction may include a predicted time window of when the hard disk drive may fail based on the measured performance and signals from the platters, or may include a likelihood of failure within a certain time window.

In some embodiments, the risk failure classification module 525 calculates a platter risk failure rating for each respective platter. The platter risk failure rating includes a classification from a set of candidate classifications. For example, risk failure classification module 525 may rate individual platters with a rating classification of 0 through 5, where 0 represents No Risk, and 5 represents Extremely High Risk, or with a rating classification of low/medium/high. The candidate classifications for platter risk failure may be the same, or different, than the set of candidate classifications for the hard disk drive failure ratings.

In some embodiments, the migration condition module 530 determines whether the aggregated hard disk drive failure prediction meets the requires of the mitigation condition specific to hard disk drives and platters. The data migration module 535, responsive to determining the hard disk drive failure prediction is associated with the migration condition relating to the platter failure prediction, migrates data on the particular hard disk drive to a second particular hard disk drive. In some embodiments, the data migration module 535 may, responsive to a platter risk failure rating, migrate data from one platter to another.

In some embodiments, the fleet 610 includes CPUs, and the storage health module 428 and included submodules may also be used to monitor the health of individual CPUs accordingly using a similar mechanism to that of monitoring storage health. The performance signal monitoring module 505 obtains performance signals from the performance data store 620 measuring the health of CPUs. The metrics for the health of the CPU would be similar to that of a hard disk drive, including items such as high temperatures over time and number of errors. The metrics for the health of a CPU may be sourced from Model Specific Registers (MSR). The machine learning model in performance learning module 515 is trained on such metrics to determine a failure prediction for each CPU. In this embodiment, the storage health module 428, responsive to the failure prediction for each CPU, determines which CPU to designate for and assign to an activity, service, or application. Such activities, services, or applications may require a high degree of confidence to prevent errors in the result. The assignment of an activity to a CPU is determined by policy pre-set by an administrator. For example, a policy may determine that for a task requiring a high degree of confidence, that task may only be assigned to a CPU with a risk level of 3 or lower, where 1 is No Risk and 5 is High Risk.

In some embodiments, the storage medium is solid-state drives. In some embodiments, the fleet 610 includes solid state drives, and the storage health module 428 and included submodules may also be used to monitor the health of the solid-state drives accordingly. Similar to other embodiments, the performance signal monitoring module 505 obtains performance signals indicating the health of a solid-state drive using the S.M.A.R.T. attributes and other related metrics. The machine learning model in the performance learning module 515 is trained on the attributes, focusing on the health of the solid-state drives. Responsive the failure predictions from the volume failure prediction module 510, the migration condition module 530 determines whether the solid-state drives meet the pre-set migration conditions. Responsive to determining that a migration condition is met, the data migration module 535 migrates and redistributes the data across the solid-state drives.

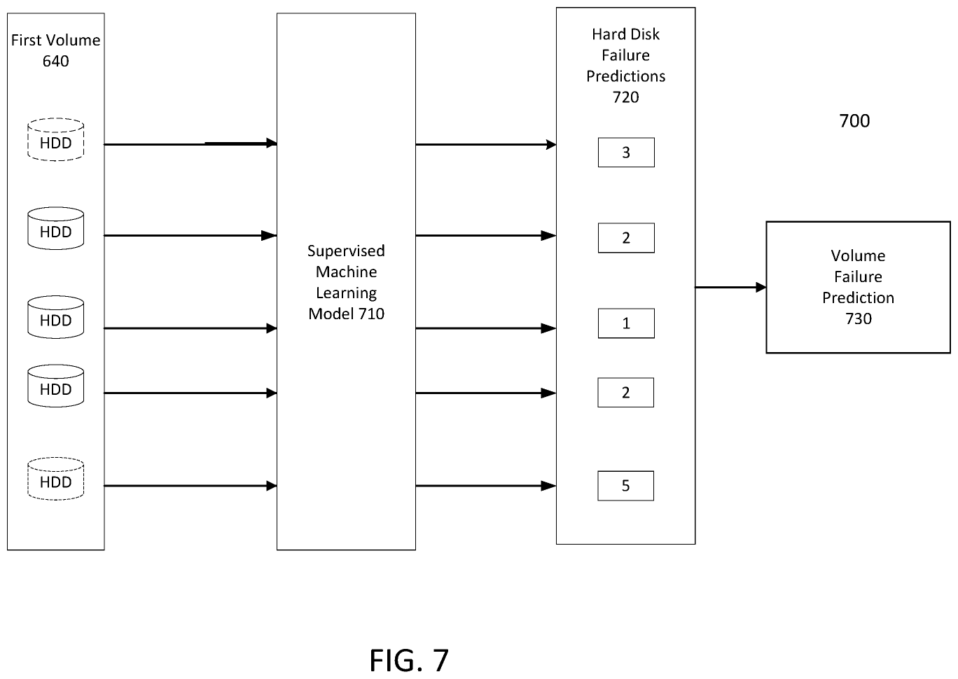

FIG. 7 shows a block diagram illustrating a process for determining a volume failure prediction, according to example embodiments. The process 700 illustrates the process of determining a volume failure prediction based on the performance signals of the individual hard disk drives in the volume of hard disk drives. The process 700 may be performed by the storage health module 428, and may be performed without human intervention.

The volume failure prediction module 510 provides the performance signals obtained by performance signal monitoring module 505 to a supervised machine learning model 710, hosted in the performance learning module 515. The supervised machine learning model 710 outputs, for each hard disk drive in first volume of hard disk drives 640, a hard disk drive failure prediction 720. The failure prediction aggregation module 520 determines a volume failure prediction 730 based on the plurality of hard disk drive failure predictions 720. The migration condition module 530 determines based on volume failure prediction 730 whether the migration condition is met, and whether any data needs to be migrated to a second volume of hard disk drives 645. Responsive to the migration condition module 530 determining that the migration condition is met, the data migration module 535 causes a migration of the data from first volume of hard disk drives 640 to second volume of hard disk drives 645, which may have a lower risk volume failure prediction 730.

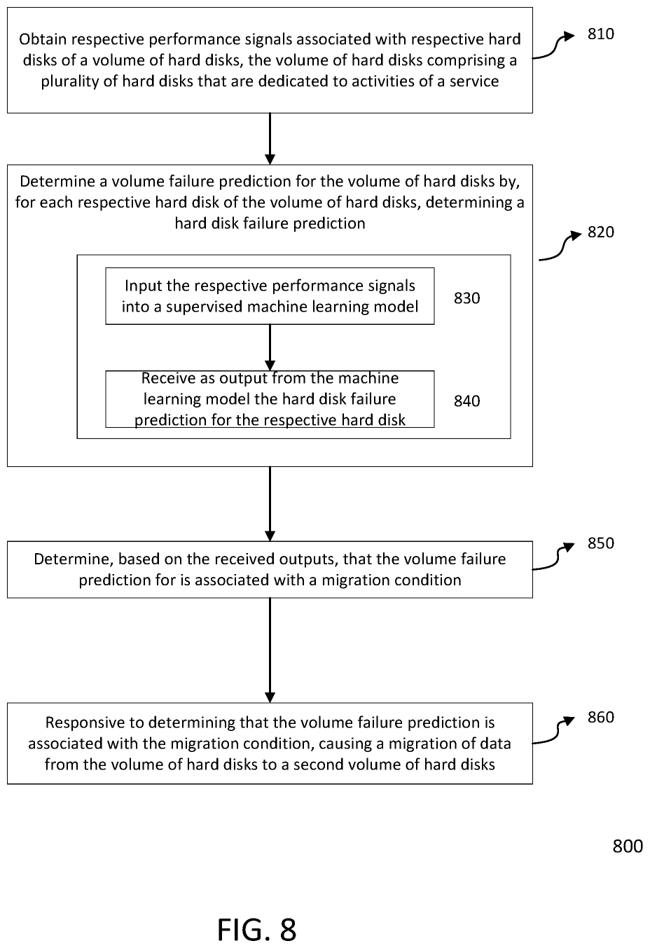

FIG. 8 shows a flowchart of an example method of a smart data placement system, according to example embodiments. The process 800 may be performed by the storage health module 428, and may be performed without human intervention. FIG. 8 is a non-limiting example of some embodiments. The process 800 may occur in alternate orders and arrangements, as well as with additional or fewer steps.

The performance signal monitoring module 505 obtains 810 performance signals associated with hard disk drives of a volume of hard disk drives, such as the first volume of hard disk drives 640, as part of the fleet of hard disk drives 610. The performance signal monitoring module 505 obtains 810 the performance signals from the performance data store 620.

The volume failure prediction module 510 determines 820 a volume failure prediction for the volume of hard disk drives. For each respective hard disk drive of the volume of hard disk drives, the volume failure prediction module 510 determines 820 a hard disk drive failure prediction. The performance learning module 515 inputs 830 the respective performance signals into a supervised machine learning model. For each respective hard disk drive of the volume of hard disk drives, the volume failure prediction module 510 inputs the respective performance signals into a supervised machine learning model hosted in performance learning module 515. The failure prediction aggregation module 520 receives 840, as output from the supervised machine learning model, the hard disk drive failure prediction for each hard disk drive of a volume, and aggregates those predictions to determine the corresponding volume failure prediction for the volume of hard disk drives.

The migration condition module 530 determines 850, based on the received output from supervised machine learning model, that the volume failure prediction is associated with a migration condition. The data migration module 535, responsive to determining that the volume failure prediction is associated with the migration condition, causes 860 a migration of data from the volume of hard disk drives 640 to a second volume of hard disk drives 645.

### Additional Considerations

Reference in the specification to “one embodiment” or to “example embodiments” means that a particular feature, structure, or characteristic described in connection with the example embodiments is included in at least one embodiment. The appearances of the phrase “in one embodiment” in various places in the specification are not necessarily all referring to the same embodiment.

In this description, the term “module” refers to a physical computer structure of computational logic for providing the specified functionality. A module can be implemented in hardware, firmware, and/or software. In regards to software implementation of modules, it is understood by those of skill in the art that a module comprises a block of code that contains the data structure, methods, classes, header and other code objects appropriate to execute the described functionality. Depending on the specific implementation language, a module may be a package, a class, or a component. It will be understood that any computer programming language may support equivalent structures using a different terminology than “module.”

It will be understood that the named modules described herein represent one embodiment of such modules, and other example embodiments may include other modules. In addition, other example embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including optical disks, CD-ROMs, read-only memories (ROMs), random access memories (RAMs), magnetic or optical cards, or any type of media suitable for storing electronic instructions, and each coupled to a computer system bus. Furthermore, the computers referred to in the specification may include a single processor or may be architectures employing multiple processor designs for increased computing capability.

The algorithms presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present technology is not described with reference to any particular programming language. It will be appreciated that a variety of programming languages may be used to implement the teachings of the present technology as described herein, and any references above to specific languages are provided for disclosure of enablement and best mode of the present technology.

While the technology has been particularly shown and described with reference to a preferred embodiment and several alternate example embodiments, it will be understood by persons skilled in the relevant art that various changes in form and details can be made therein without departing from the spirit and scope of the technology.

As used herein, the word “or” refers to any possible permutation of a set of items. Moreover, claim language reciting ‘at least one of’ an element or another element refers to any possible permutation of the set of elements.

Although this description includes a variety of examples and other information to explain embodiments within the scope of the appended claims, no limitation of the claims should be implied based on particular features or arrangements these examples. This disclosure includes specific example embodiments and implementations for illustration, but various modifications can be made without deviating from the scope of the example embodiments and implementations. For example, functionality can be distributed differently or performed in components other than those identified herein. This disclosure includes the described features as non-exclusive examples of systems components, physical and logical structures, and methods within its scope.

Finally, it should be noted that the language used in the specification has been principally selected for readability and instructional purposes, and may not have been selected to delineate or circumscribe the inventive subject matter. Accordingly, the disclosure of the present technology is intended to be illustrative, but not limiting, of the scope of the technology, which is set forth in the following claims.

1. A method comprising:
obtaining respective performance signals associated with respective hard disk drives of a collection of hard disk drives, the collection of hard disk drives comprising a plurality of hard disk drives that are dedicated to activities of a service;
determining a collection failure prediction for the collection of hard disk drives by, for each respective hard disk drive of the collection of hard disk drives, determining a hard disk drive failure prediction by:
inputting the respective performance signals into a supervised machine learning model; and
receiving, as output from the supervised machine learning model, the hard disk drive failure prediction for the respective hard disk drive;
determining, based on the received outputs, that the collection failure prediction is associated with a migration condition; and
responsive to determining that the collection failure prediction is associated with the migration condition, causing a migration of data from the collection of hard disk drives to a second collection of hard disk drives.

2. The method of claim 1, wherein determining the hard disk drive failure prediction further comprises:
obtaining respective performance signals associated with respective platters of a particular hard disk drive; and
for each respective platter of the particular hard disk drive:
inputting the respective performance signals associated with each respective platter into a second supervised machine learning model; and
receiving as output from the second supervised machine learning model a platter failure prediction for the respective platter.

3. The method of claim 2, wherein determining the hard disk drive failure prediction further comprises:
determining, based on the platter failure prediction, that the hard disk drive failure prediction is associated with a second migration condition; and
responsive to determining the hard disk drive failure prediction is associated with the second migration condition, causing a migration of data on the particular hard disk drive to a second particular hard disk drive.

4. The method of claim 2, wherein determining the hard disk drive failure prediction, further comprises, responsive to receiving the platter failure prediction as output, calculating a platter risk failure rating for each respective platter, the platter risk failure rating comprising a second classification of a given second plurality of candidate classifications.

5. The method of claim 1, wherein the collection of hard disk drives comprises a number of hard disk drives, and wherein the method further comprises:
identifying a second number of hard disk drives to be included in the second collection of hard disk drives, wherein the number of hard disk drives in the collection of hard disk drives is not equal to the second number of hard disk drives to be included in the second collection of hard disk drives.

6. The method of claim 1, wherein the determining the collection failure prediction, further comprises, responsive to receiving the hard disk drive failure prediction as output, calculating a risk failure rating for each respective hard disk drive, the risk failure rating comprising a classification of a given plurality of candidate classifications.

7. The method of claim 6, wherein determining, based on the received outputs, that the collection failure prediction is associated with the migration condition further comprises:
determining a number of respective hard disk drives which received a given classification, wherein the given classification is associated with a threshold associated with the migration condition; and
determining that the number of respective hard disk drives which received the given classification satisfies the threshold associated with the migration condition.

8. A non-transitory computer-readable storage medium storing executable computer instructions that, when executed by one or more processors, cause the one or more processors to perform operations comprising:
obtaining respective performance signals associated with respective hard disk drives of a collection of hard disk drives, the collection of hard disk drives comprising a plurality of hard disk drives that are dedicated to activities of a service;
determining a collection failure prediction for the collection of hard disk drives by, for each respective hard disk drive of the collection of hard disk drives, determining a hard disk drive failure prediction by:
inputting the respective performance signals into a supervised machine learning model; and
receiving as output from the supervised machine learning model the hard disk drive failure prediction for the respective hard disk drive;
determining, based on the received outputs, that the collection failure prediction is associated with a migration condition; and
responsive to determining that the collection failure prediction is associated with the migration condition, causing a migration of data from the collection of hard disk drives to a second collection of hard disk drives.

9. The non-transitory computer-readable storage medium of claim 8, wherein determining the hard disk drive failure prediction further comprises:
obtaining respective performance signals associated with respective platters of a particular hard disk drive; and
for each respective platter of the particular hard disk drive:
inputting the respective performance signals associated with each respective platter into a second supervised machine learning model; and
receiving as output from the second supervised machine learning model a platter failure prediction for the respective platter.

10. The non-transitory computer-readable storage medium of claim 9, wherein determining the hard disk drive failure prediction further comprises:
determining, based on the platter failure prediction, that the hard disk drive failure prediction is associated with a second migration condition; and
responsive to determining the hard disk drive failure prediction is associated with the second migration condition, causing a migration of data on the particular hard disk drive to a second particular hard disk drive.

11. The non-transitory computer-readable storage medium of claim 9, wherein determining the hard disk drive failure prediction, further comprises, responsive to receiving the platter failure prediction as output, calculating a platter risk failure rating for each respective platter, the platter risk failure rating comprising a second classification of a given second plurality of candidate classifications.

12. The non-transitory computer-readable storage medium of claim 8, wherein the collection of hard disk drives comprises a number of hard disk drives, and wherein the operations further comprise:
identifying a second number of hard disk drives to be included in the second collection of hard disk drives, wherein the number of hard disk drives in the collection of hard disk drives is not equal to the second number of hard disk drives to be included in the second collection of hard disk drives.

13. The non-transitory computer-readable storage medium of claim 8, wherein the determining the collection failure prediction, further comprises, responsive to receiving the hard disk drive failure prediction as output, calculating a risk failure rating for each respective hard disk drive, the risk failure rating comprising a classification of a given plurality of candidate classifications.

14. The non-transitory computer-readable storage medium of claim 13, wherein determining, based on the received outputs, that the collection failure prediction is associated with a migration condition further comprises:
determining a number of respective hard disk drives which received a given classification, wherein the given classification is associated with a threshold associated with the migration condition; and
determining that the number of respective hard disk drives which received the given classification satisfies the threshold associated with the migration condition.

15. A system comprising:
memory with instructions encoded thereon; and
one or more processors that, when executing the instructions, are caused to perform operations comprising:
obtaining respective performance signals associated with respective hard disk drives of a collection of hard disk drives, the collection of hard disk drives comprising a plurality of hard disk drives that are dedicated to activities of a service;
determining a collection failure prediction for the collection of hard disk drives by, for each respective hard disk drive of the collection of hard disk drives, determining a hard disk drive failure prediction by:
inputting the respective performance signals into a supervised machine learning model;
receiving as output from the supervised machine learning model the hard disk drive failure prediction for the respective hard disk drive;
determining, based on the received outputs, that the collection failure prediction is associated with a migration condition; and
responsive to determining that the collection failure prediction is associated with the migration condition, causing a migration of data from the collection of hard disk drives to a second collection of hard disk drives.

16. The system of claim 15, wherein determining the hard disk drive failure prediction further comprises:
obtaining respective performance signals associated with respective platters of a particular hard disk drive; and
for each respective platter of the particular hard disk drive:
inputting the respective performance signals associated with each respective platter into a second supervised machine learning model; and
receiving as output from the second supervised machine learning model a platter failure prediction for the respective platter.

17. The system of claim 16, wherein determining the hard disk drive failure prediction further comprises:
determining, based on the platter failure prediction, that the hard disk drive failure prediction is associated with a second migration condition; and
responsive to determining the hard disk drive failure prediction is associated with the second migration condition, causing a migration of data on the particular hard disk drive to a second particular hard disk drive.

18. The system of claim 15, wherein the collection of hard disk drives comprises a number of hard disk drives, and wherein the operations further comprises:
identifying a second number of hard disk drives to be included in the second collection of hard disk drives, wherein the number of hard disk drives in the collection of hard disk drives is not equal to the second number of hard disk drives to be included in the second collection of hard disk drives.

19. The system of claim 15, wherein determining the collection failure prediction, further comprises, responsive to receiving the hard disk drive failure prediction as output, calculating a risk failure rating for each respective hard disk drive, the risk failure rating comprising a classification of a given plurality of candidate classifications.

20. The system of claim 19, wherein determining, based on the received outputs, that the collection failure prediction is associated with a migration condition further comprises:
determining a number of respective hard disk drives which received a given classification, wherein the given classification is associated with a threshold associated with the migration condition; and
determining that the number of respective hard disk drives which received the given classification satisfies the threshold associated with the migration condition.
